(19) United States
(12) Patent Application Publication
(10) Pub. No.: US 2015/0000449 A1
(43) Pub. Date: Jan. 1, 2015

(54) RANGE SWITCH DEVICE

(71) Applicant: DENSO CORPORATION, Kariya-city (JP)

(72) Inventors: Koji SAKAGUCHI, Obu-city (JP); Kazuhiro YOSHIDA, Tokoname-city (JP)

(21) Appl. No.: 14/315,662

(22) Filed: Jun. 26, 2014

(30) Foreign Application Priority Data
Jun. 27, 2013 (JP) 2013-135425

(51) Int. Cl. F16H 61/02

(52) U.S. Cl. CPC F16H 61/0204
USPC 74/473.12

(57) ABSTRACT

A range switch device has a range switch control without an abutment control of a motor. The range switch control detects an encoder count at a slack removed rotation position of the motor during a rotation to a target rotation position at a shift range switch time. Then, the range switch control sets the target rotation position based on the slack removed rotation position of the motor and a by-design rotation amount of the motor, in which the slack removed rotation position is detected by an encoder count that marks an output change start time of a rotation sensor and a by-design rotation amount between pre- and post-switching rotation positions regarding pre- and post-switching shift ranges.

### CROSS REFERENCE TO RELATED APPLICATION

The present application is based on and claims the benefit of priority of Japanese Patent Application No. 2013-135425, filed on Jun. 27, 2013, the disclosure of which is incorporated herein by reference.

### TECHNICAL FIELD

The present disclosure generally relates to a range switch device that utilizes a motor to switch a shift range.

### BACKGROUND INFORMATION

In recent years, manual operations of apparatuses within vehicles, as well as in other devices, are increasingly being replaced by motor-driven operations that utilize electric motors. Motor-driven operations provide many benefits, such as space-savings, ease of assembly, improved controllability, and the like. An automatic transmission range switch mechanism within a vehicle is an example of such a replacement of a manual operation to a motor-driven operation. Such a mechanism is equipped with an encoder that is synchronized with the motor and outputs a pulse signal at every given angle of rotation of the motor. In operation, when a gear shift position of the automatic transmission is changed, the motor is driven to a target rotation position that corresponds to a target shift range and the automatic transmission is shifted to the target shift range.

In this case, a rotation amount or a rotation angle of the motor is converted to an operation amount of a range switch mechanism by a rotation transmission system, such as a deceleration mechanism, which inevitably includes slack, play, backlash, looseness, etc. within the operation amount. That is, backlash of a gear in the deceleration mechanism may be included as slack in the operation amount of the range switch mechanism, or a connection between a rotation shaft of the deceleration mechanism and an engagement hole on an operation stick of the range switch mechanism, which occurs as an engagement of a non-circular end (e.g., a square shape end, or a D-cut shape end) of the rotation shaft with the engagement hole of the operation stick, requires a clearance for the ease of inserting the end of the shaft into the engagement hole. Therefore, due to the slack in the rotation transmission system, even when the rotation amount of the motor is intended to be accurately controlled based on the encoder count, for example, the accuracy of such control may still be deteriorated.

Thus, as disclosed in a patent document 1 (i.e., Japanese patent No. 3849864), a slack learning scheme has been proposed, in which the motor is rotated to a limit position of a movable range of the range switch mechanism, which may be designated as an abutment control of the motor, upon starting an operation of the controller (e.g., when an ignition switch is turned ON), for learning a slack amount in the rotation transmission mechanism. Such a slack amount may then be used to set the target rotation position, for the improved accuracy of the control at a range switch time.

However, the shift range at the controller operation start time may not always be in an abutted shift range. For example, the shift range at the controller operation start time may be in an N range, which is not a range in which an abutment control is performable. In such a case, i.e., when the shift range is not an abutment control performable shift range (i.e., an abutted shift range), the slack amount cannot be immediately learned based on the slack learning scheme of the patent document 1, thereby not improving accuracy for the range switch operation. Further, switching from a non-abutted shift range to the abutted shift range for performing the abutment control takes time, which causes a delay when switching from a current shift range to a target shift range.

### SUMMARY

It is an object of the present disclosure to provide a range switch device that is capable of accurately switching between shift ranges without performing an abutment control for rotating a motor to a limit position of a movable range of a range switch mechanism.

In an aspect of the present disclosure, the range switch device includes a range switch mechanism having a plurality of shift ranges, a motor driving an operating shaft of the range switch mechanism to switch a shift range between one of the plurality of shift ranges, and an encoder sensing a rotation of the motor and outputting a pulse signal in synchronization with the rotation of the motor. The range switch device also includes a controller controlling the motor to rotate, based on an encoder count of the output of the pulse signal from the encoder, to a target rotation position that corresponds to a target shift range to switch the shift range to the target shift range, a rotation sensor outputting an output signal according to a rotation angle of the operating shaft of the range switch mechanism which is rotated by the motor, and a target rotation position setting part detecting a slack removed position of the motor and setting the target rotation position when the motor rotates to switch to the target rotation position. The slack removed position is defined as a rotation position of the motor based on an encoder count that indicates a start of a changing of the output signal from the rotation sensor. The target rotation position of the motor is set based on (a) the slack removed position of the motor and (b) a by-design rotation amount of the motor between a pre-switching shift range and the target shift range.

When the motor is rotated to a range having slack just after a start of motor rotation, the motor rotation does not cause a rotation of the operating shaft of the range switch mechanism, thereby not causing a change in the output from the rotation sensor. However, when the amount of slack (e.g., a backlash) within the rotation transmission system is entirely removed after a small amount of the motor rotation, the operating shaft of the range switch mechanism starts to rotate, thereby causing a change in the output of the rotation sensor.

In view of such characteristics, a slack removal scheme of the present disclosure detects a slack removed rotation position of the motor as the encoder count at an output change start time that marks a start of a changing of the output (i.e., the signal) from the rotation sensor by rotating the motor toward the target rotation position when the shift range is switched to a certain target shift range. That is, a slack removed rotation position of the motor at which the slack of the rotation transmission system is removed, after a small amount of rotation toward the target rotation position is detected in the above-described manner. Then, the target rotation position is set up based on (i) the slack removed rotation position and (ii) a by-design value of a rotation amount between a pre-switching rotation position corresponding to a current shift range and a post-switching rotation position corresponding to a target shift range. In such manner, without learning an amount of slack in the rotation transmission system, the target rotation position is accurately set for the switching of the shift range to the target range, thereby achieving and improving an accuracy of control at a shift range switch time without performing an abutment control for rotating the motor to the limit position of the movable range of the range switch mechanism.

Further, in another aspect of the present disclosure, the range switch device includes a range switch mechanism having a plurality of shift ranges, a motor driving an operating shaft of the range switch mechanism to switch a shift range between one of the plurality of shift ranges, and an encoder sensing a rotation of the motor and outputting a rotation position of the motor as an encoder count. The range switch device also includes a controller controlling the motor to rotate, based on the encoder count, to a target rotation position that corresponds to a target shift range to switch the shift range to the target shift range, a rotation sensor outputting a signal indicative of a rotation angle of an operating shaft of the range switch mechanism which is rotated by the motor, and a slack amount learning part that learns, when a preset learn condition is fulfilled, an amount of slack in a rotation transmission system that transmits a rotation of the motor based on (i) a first encoder count of the rotation sensor at a first output change start time when the motor rotates relative to the initial position along a first rotation direction, and (ii) a second encoder count of the rotation sensor at a second output change start time when the motor rotates relative to the initial position along a second rotation direction that is opposite to the first rotation direction. Further, the range switch device includes a target rotation position setting part that sets, when the motor is caused to rotate to switch the shift range, the target rotation position according to a learned value of the amount of slack.

The first encoder count of the rotation sensor at the first output change start time, which is when the motor rotation is caused from the initial position along the first rotation direction and the output of the rotation sensor starts to change, indicates a first slack removed rotation position in such rotation direction in which no slack of the rotation transmission system is left un-removed. The second encoder count of the rotation sensor at the second output change start time, which is when the motor rotation is caused from the initial position along the second rotation direction opposite to the first rotation direction and the output of the rotation sensor starts to change, indicates a second slack removed rotation position in such rotation direction in which no slack of the rotation transmission system is left un-removed.

Therefore, based on the first and second encoder counts at the first/second output change start times, which respectively mark first/second timings of when the sensor output starts to change (i.e., when the motor is rotated to a slack removed rotation position along the respective rotation directions), the amount of slack in the rotation transmission system is accurately learned. Further, when the switching of the shift range is performed, such an amount of slack is taken into consideration for the setting of the target rotation position, for an accurate setting of the target rotation position. Therefore, without performing an abutment control that rotates the motor to the limit position of the movable range of the range switch mechanism, an accuracy of control at a shift range switch time is ensured.

### BRIEF DESCRIPTION OF THE DRAWINGS

Objects, features, and advantages of the present disclosure will become more apparent from the following detailed description made with reference to the accompanying drawings, in which:

FIG. 1 is a perspective view of a range switch device in a first embodiment of the present disclosure;

FIG. 2 is a configuration diagram of a control system of the range switch device;

FIG. 3 is an illustration diagram depicting a setting of a target rotation position in a first embodiment;

FIG. 4 is another illustration diagram depicting the setting of the target rotation position in the first embodiment;

FIG. 5 is a flowchart of a target rotation position setting routine in the first embodiment;

FIG. 6 is a flowchart of a target rotation position re-setting routine in the first embodiment;

FIG. 7 is a time chart depicting a performing of the target rotation position setting in the first embodiment;

FIG. 8 is an illustration diagram depicting a learning of an amount of slack in a second embodiment;

FIG. 9 is another illustration diagram depicting the learning of an amount of slack in the second embodiment;

FIG. 10 is yet another illustration diagram depicting the learning of an amount of slack in the second embodiment;

FIG. 11 is a flowchart of a slack amount learning routine in the second embodiment;

FIG. 12 is a flowchart of a learning complete flag setting routine in the second embodiment;

FIG. 13 is a flowchart of the target rotation position setting routine in the second embodiment; and

FIG. 14 is a time chart depicting the performing of the slack amount learning in the second embodiment.

### DETAILED DESCRIPTION

Embodiments of the present disclosure are described in the following with reference to the drawings.

### First Embodiment

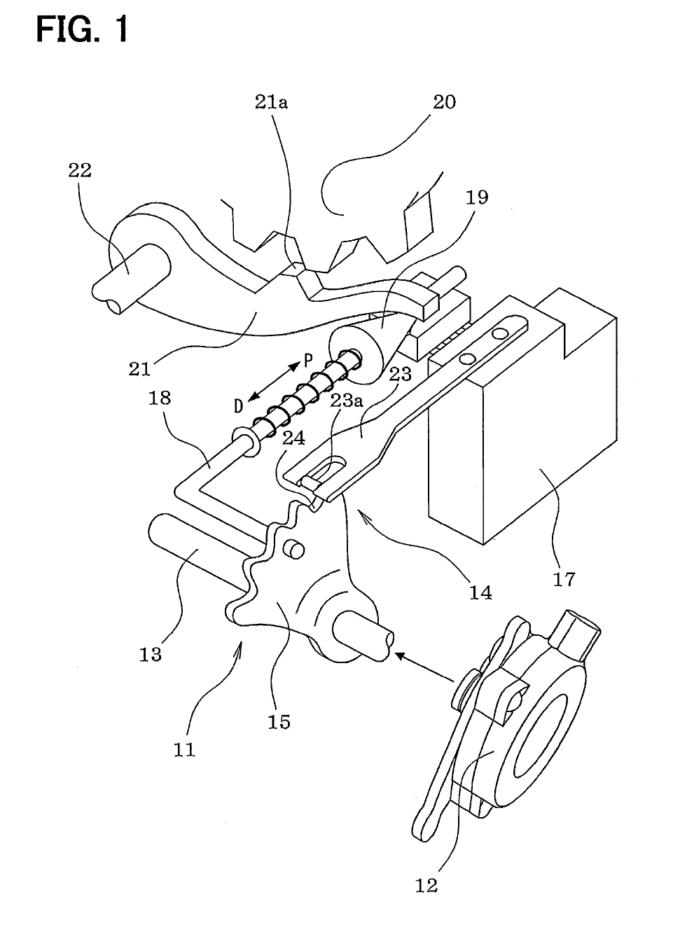

The first embodiment of the present disclosure is described with reference to FIG. 1 to FIG. 7.

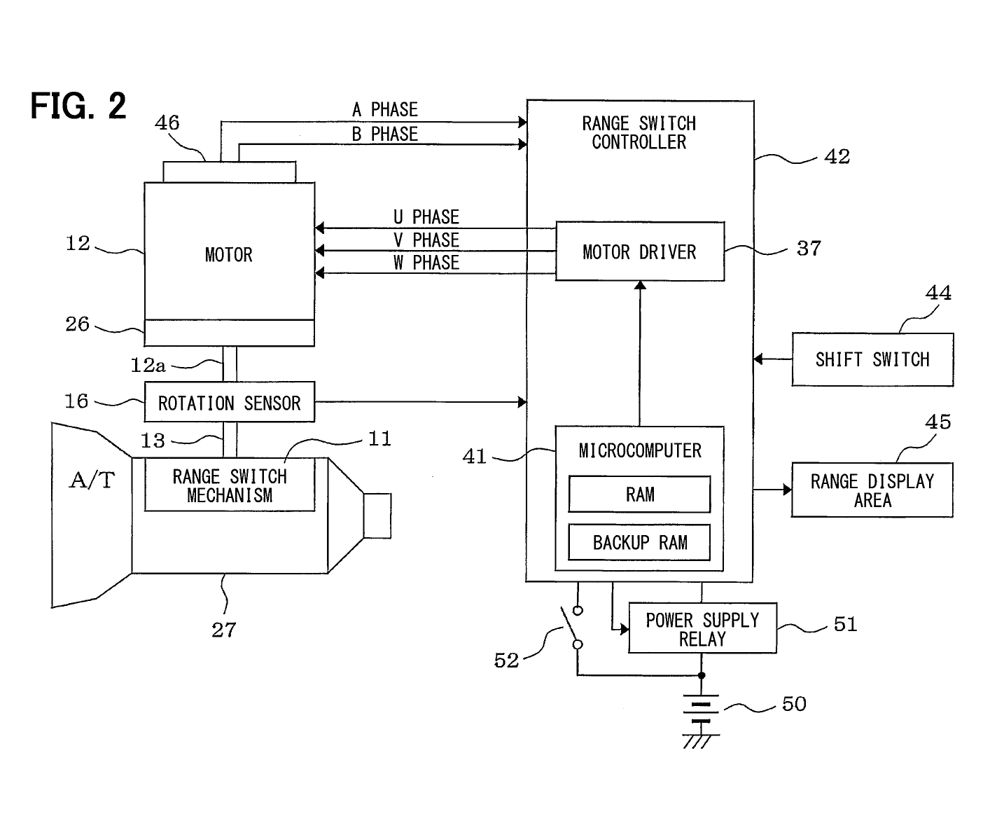

First, a structure of a range switch mechanism 11 is described with reference to FIG. 1 and FIG. 2.

As shown in FIG. 1, the range switch mechanism 11 is a 4-position type range switch mechanism for switching the shift range of an automatic transmission 27 (see FIG. 2) among four positions, which may include a P range (i.e., a parking range), an R range (i.e., a reverse range), an N range (i.e., a neutral range), and a D range (i.e., a drive range). The motor 12 may be a switched-reluctance motor, for example, which may be used to drive the range switch mechanism 11. As shown in FIG. 2, the motor 12 has a built-in deceleration mechanism 26, and a manual shaft 13 (i.e., an operation shaft) of the range switch mechanism 11 is connected to an output shaft 12a of the motor 12. A detent lever 15 is fixedly disposed onto the manual shaft 13.

The detent lever 15 is connected to a manual valve (not illustrated) which performs a linear motion according to a rotation of the detent lever 15. Such a manual valve is used to switch to an internal hydraulic circuit (not shown) within an inside of the automatic transmission 27.

A parking rod 18 is formed in an L-shape and fixed onto the detent lever 15. A cone body 19 is provided at a tip part of the parking rod 18 and in contact with a locking lever 21. According to the position of the cone body 19, the locking lever 21 moves (i.e., rotates) up and down centering on the shaft 22 to lock and unlock a parking gear 20. The parking gear 20 is disposed on the output axis of the automatic transmission 27, and, when the parking gear 20 is locked by the locking lever 21, the driving wheels of the vehicle are held in a locked state (i.e., a parking state) in which the wheels are prevented from rotating.

A detent spring 23 is fixed on a support base 17 and holds the detent lever 15 in each of the P, R, N, and D ranges. The detent lever 15 has a range detention concave part 24 (see FIG. 1) for each of the P, R, N, and D range, and, when an engagement part 23a provided at the tip of the detent spring 23 is engaged with one of the range detention concave parts 24, the detent lever 15 is held in the position of each of those ranges. In combination, the detent lever 15 and the detent spring 23 serve as the detent mechanism 14 (i.e., a detent) to engaging and hold the rotation position of the detent lever 15 within one of the four ranges (i.e., a device for holding the range switch mechanism 11 at one of the plural range positions).

In the P range, the parking rod 18 moves closer to the locking lever 21 such that a thick portion of the cone body 19 pushes the locking lever 21 upward. In turn, a convex part 21 a of the locking lever 21 engages the parking gear 20 to lock the parking gear 20 and hold the output shaft (i.e., driving wheels) of the automatic transmission 27 in a locked state (i.e., a parking state of the vehicle).

In the R, N, and D ranges, the parking rod 18 moves away from the locking lever 21 such that the thick portion of the cone body 19 is pulled out from below the locking lever 21. In turn, the lever 21 moves downward and the convex part 21a of the locking lever 21 moves away from the parking gear 20 to release the lock of the locking lever 21. As a result, the output shaft of the automatic transmission 27 is rotatable state (i.e., a travelable state of the vehicle).

Further, on the manual shaft 13 of the range switch mechanism 11, a rotation sensor 16 is disposed, which detects a rotation angle (i.e., a rotation position) of the manual shaft 13. The rotation sensor 16 is provided as a sensor (e.g., a potentiometer) that outputs a voltage according to the rotation angle of the manual shaft 13, which indicates where an actual shift position is currently put in among the P, R, N and D ranges.

As shown in FIG. 2, the encoder 46 is provided in the motor 12 to detect the rotation angle (i.e., a rotation position) of a rotor. The encoder 46 is implemented as a magnetic type rotary encoder, for example, and is configured to output a pulse signal of an A-phase and a pulse signal of a B-phase that is in synchronization with the rotation of the rotor of the motor 12. The encoder 46 outputs the pulse signal to a range switch controller 42 at every predetermined angle. The microcomputer 41 of the range switch controller 42 counts both a rising edge and a falling edge of the A-phase signal and the B-phase signal, which are then outputted from the encoder 46. The motor 12 is rotated based on the switching of the power supply phases of the motor 12 in a given order by a motor driver 37 according to the count value (hereinafter encoder count value). Further, two systems (i.e., two combinations) of three-phase (i.e., U, V, W phases) windings of the motor 12 and the motor driver 37 may be provided for the contingency operation of the motor 12. That is, an operation of the motor 12 is enabled to continue by using one functioning system even when one of the two systems breaks down.

During the rotation of the motor 12, a rotation direction of the motor 12 is determined based on an order of generating the A-phase signal and the B-phase signal. The encoder count value is counted upward when the rotation direction is determined as a positive rotation (i.e., a rotation direction from the P range toward the D range), and the encoder count value is counted downward when the rotation direction is determined as a reverse rotation (i.e., a rotation direction from the D range toward the P range). Since the correspondence between the encoder count value and the rotation angle of the motor 12 is maintained in both of the two rotation directions of the motor 12, the rotation of the motor 12 in both of the two rotation directions is controllable by the power supply for the winding in a corresponding phase that corresponds to the rotation position of the motor 12 based on the rotation position detected by the encoder count value.

A signal of a shift lever operation position detected by the shift switch 44 is input to the range switch controller 42. According to such input, that is, according to the driver's operation of the shift lever, the microcomputer 41 (i.e., a controller) of the range switch controller 42 switches a target shift range, and drives the motor 12 according to the target shift range to switch the shift range. After the switching of the shift ranges, the controller 42 displays the actual shift range on a range display area 45 that is disposed on an instrument panel (not shown).

A power supply voltage is supplied for the range switch controller 42 via a power supply relay 51 from a battery 50 (i.e., a power supply) in the vehicle. The ON and OFF of the power supply relay 51 are switched by manually operating/switching an IG switch 52 ON and OFF (i.e., an ignition switch) which is an electric power switch. When the IG switch 52 is turned ON, the power supply relay 51 is turned ON and the power supply voltage is supplied for the range switch controller 42. When the IG switch 52 is turned OFF, the power supply relay 51 is turned OFF and the power supply for the range switch controller 42 is interrupted (i.e., is turned OFF).

When the target range is switched according to a manual operation of the shift lever by the driver, the microcomputer 41 performs a feedback control for rotating the motor 12 to the target rotation position. To perform the feedback control, the microcomputer 41 changes a target rotation position (i.e., a target count value) according to the manual operation of the shift lever and sequentially switches the power supply phases of the motor 12 based on the encoder count value, for switching the shift range to the target range (i.e., for the switching of a switch position of the range switch mechanism 11 to a position of the target range).

In such a case, a rotation amount (i.e., a rotation angle) of the motor 12 is converted to an operation amount of the range switch mechanism 11 by a rotation transmission system, such as the deceleration mechanism 26, which inevitably includes slack, backlash, looseness, etc. in the operation amount. That is, in more detail, (A) a backlash of a gear in the deceleration mechanism 26 may be included as slack in the operation amount of the range switch mechanism 11, or (B) a connection between the output shaft 12a of the deceleration mechanism 26 and an engagement hole on the manual shaft 13 of the range switch mechanism 11, which is made as an engagement of a non-circular end (e.g., a square shape end, or a D-cut shape end) of the output shaft 12a with the engagement hole of the manual shaft 13, requires a clearance for the ease of insertion operation for inserting the end of the output shaft 12a into the engagement hole. Therefore, due to the slack in the rotation transmission system for converting the rotation amount of the motor 12 to the operation amount of the range switch mechanism 11, even when the rotation amount (i.e., the rotation angle) of the motor 12 is intended to be accurately controlled based on the encoder count, for example, the accuracy of such control may still be deteriorated.

Therefore, when the microcomputer 41 of the range switch controller 42 is started (e.g., when the IG switch 52 is turned ON), a certain slack learning scheme may be performed, in which the motor 12 is rotated to a limit position of a movable range of the range switch mechanism 11 for learning a slack amount of the rotation transmission mechanism. A learned value of such a slack amount may then be considered to set the target rotation position, for the improved accuracy of the control at a range switch time.

However, the shift range at start time of the microcomputer 41 of the range switch controller 42 (e.g., when the IG switch 52 is turned ON) may not always be in an abutted shift range. For example, the shift range at the start time of the microcomputer 41 may be in an N range, which is not a range (e.g., P range) in which an abutment control is performable. In such a case, when the shift range is not an abutment control performable shift range, the slack amount in the rotation transmission system cannot be immediately learned by performing the abutment control.

Thus, in the present embodiment, the microcomputer 41 of the range switch controller 42 performs each of the following two routines, i.e., a target rotation position setting routine and a target rotation position re-setting routine, for the accuracy of the range switch control. That is, a slack removal scheme of the present embodiment detects a slack removed rotation position of the motor 12 as the encoder count at an output change start time that marks (i.e., indicates) a start of changing of the output (i.e., the signal) from the rotation sensor 16 by rotating the motor 12 toward the target rotation position when a current shift range is switched to a certain target shift range. That is, a slack removed rotation position of the motor 12 at which the slack of the rotation transmission system is removed, after a small amount of rotation toward the target rotation position is detected in the above-described manner. Then, the target rotation position is set up based on (i) the slack removed rotation position (i.e., of the motor 12) and (ii) a by-design value of a rotation amount (i.e., of the motor 12) between a pre-switching rotation position corresponding to the current shift range and a post-switching rotation position corresponding to a target shift range.

When the motor 12 is rotated to a range having slack just after a start of motor rotation), the motor rotation does not cause a rotation of the manual shaft 13 of the range switch mechanism 11, thereby not causing a change in the output from the rotation sensor. However, when the slack (e.g., a backlash) of the rotation transmission system is entirely removed after a small amount of the motor rotation, the manual shaft 13 of the range switch mechanism 11 starts to rotate, thereby causing a change in the output of the rotation sensor 16.

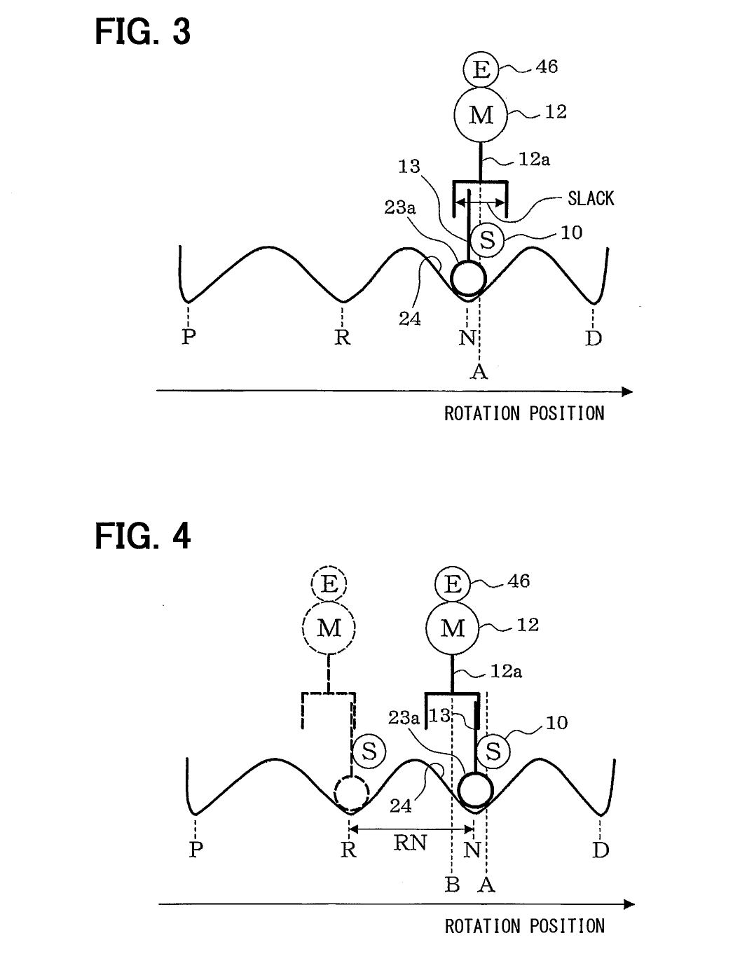

In view of such characteristics, the slack is removed in the following manner in the present embodiment. That is, in case that (i) the shift range at the start time of the microcomputer 41 is in the N range, for example, which is not a range in which an abutment control is performable, as shown in FIG. 3, and (ii) the current shift range is switched to the other range (e.g., the N range is switched to an R range), the motor 12 is rotated in a direction toward the post-switching target range, i.e., toward the R range in this case.

Then, as represented by solid lines in FIG. 4, the encoder count is in a slack removed state, in which (i) the slack of the rotation transmission system is removed in the target range direction and (ii) the changing of the output from the rotation sensor 16 is started, and is detected as an indicator of a slack removed rotation position B. In such manner, a rotation position at which the slack of the rotation transmission system is removed in the target range direction (e.g., after a small amount motor rotation toward the R range) is detected and marked as the slack removed rotation position B.

Then, a target rotation position is set up based on (i) the slack removed rotation position B and (ii) a by-design value RN of the rotation amount from a rotation position of the pre-switching (i.e., current) shift range (e.g., N range) to a rotation position of the post-switching (i.e., target) shift range (e.g., R range).

Target rotation position=B−RN

Thereby, even without learning a slack amount in the rotation transmission system, a target rotation position for switching the shift range to a target range (e.g., R range) is with improved set with improved accuracy.

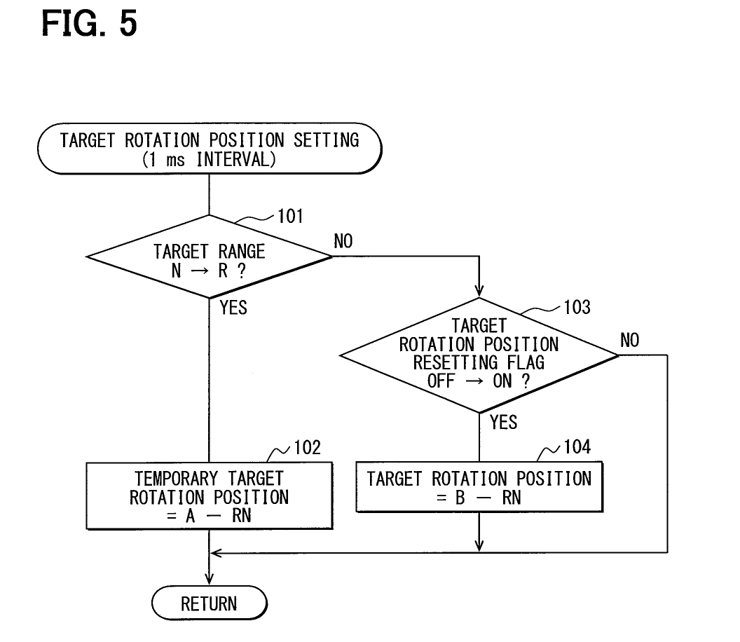

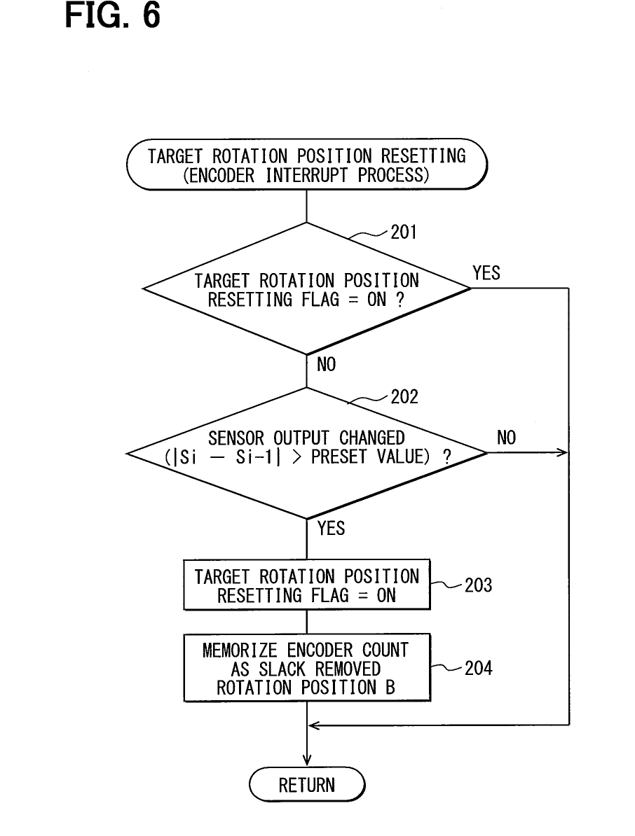

Hereafter, the contents of process of each of the two routines shown in FIGS. 5 and 6, which are performed by the microcomputer 41 of the range switch control 42, are described.

[Target Rotation Position Setting Routine]

The target rotation position setting routine shown in FIG. 5 is repeatedly executed at predetermined intervals (e.g., at a cycle of 1 ms) by the microcomputer 41 during a power turn-ON period of the range switch controller 42.

After the start of the present routine, it is firstly determined in step 101 whether it is a range switch timing for switching a target range from the N range to the R range.

When it is determined that the target range is switched to the R range from the N range in step 101, the process proceeds to step 102, and a temporary target rotation position is set up based on (i) an initial rotation position A (i.e., a stop position before rotating the motor 12) and (ii) a by-design value RN of the rotation amount from a rotation position corresponding to the N range to a rotation position corresponding to the R range.

Temporary target rotation position=A−RN

According to the above, the microcomputer 41 of the range switch controller 42 rotates the motor 12 in the R range direction.

When, thereafter (i.e., a later cycle of execution of the present routine), it is determined, in the above-mentioned step 101, that it is not a range switch timing for switching the target range from the N range to the R range, the process proceeds to step 103, and determines whether it is a flag switching timing for switching a target rotation position resetting flag from OFF to ON. The target rotation position resetting flag is set up by the routine of FIG. 6, which is mentioned later.

When it is determined that it is not a flag switching timing for switching the target rotation position resetting flag from OFF to ON in step 103, this routine is finished without performing a process of step 104.

When, thereafter, it is determined as the flag switching timing of switching the target rotation position resetting flag from OFF to ON in the above-mentioned step 103, the process proceeds to step 104, and the target rotation position is set up based on (i) the slack removed rotation position B and (ii) the by-design value RN of the rotation amount from a rotation position corresponding to the N range to a rotation position corresponding to the R range. The slack removed rotation position B is detected by the routine of FIG. 6, which is mentioned later.

Target position=B−RN

Thereby, the microcomputer 41 of the range switch controller 42 rotates the motor 12 to a target rotation position (=B−RN), and switches a shift range to the R range.

[Target Rotation Position Resetting Routine]

The target rotation position resetting routine shown in FIG. 6 is started by the microcomputer 41 during the power turn-ON period of the range switch controller 42 in synchronization with both of a rising edge and a falling edge of an A-phase signal and a B-phase signal, which are outputted from an encoder interrupt process from the encoder 46.

After the start of the present routine, it is determined in step 201 whether the target rotation position resetting flag is ON.

When it is determined as a target rotation position resetting flag being OFF in this step 201, the process proceeds to step 202, and it is determined whether the output of the rotation sensor 16 has changed based on, for example, whether an absolute value of difference between a current output value Si and a previous output value Si−1 of the rotation sensor 16 is greater than a predetermined value (e.g., zero or a value greater than zero).

The present routine is finished without performing a process of steps 203, 204, when it is determined that the output of the rotation sensor 16 has not changed in step 202.

When, thereafter, it is determined that the output of the rotation sensor 16 has changed in the above-mentioned step 202, the process proceeds to step 203, and, after setting a target rotation position resetting flag to ON, the process proceeds to step 204, and detects and memorizes a current encoder count (i.e., an encoder count when the output of the rotation sensor 16 starts to change) as the slack removed rotation position B.

Then, it is determined that the target rotation position resetting flag is ON in the above-mentioned step 201, the present routine is finished without performing a process of step 202 and subsequent steps. Further, the target rotation position resetting flag is reset to OFF when, for example, the motor 12 is rotated to a target rotation position to switch a shift range to the R range.

In the present embodiment, the target rotation position setting routine of FIG. 5 and the target rotation position resetting routine of FIG. 6 serve as a target rotation position setting part in the claims.

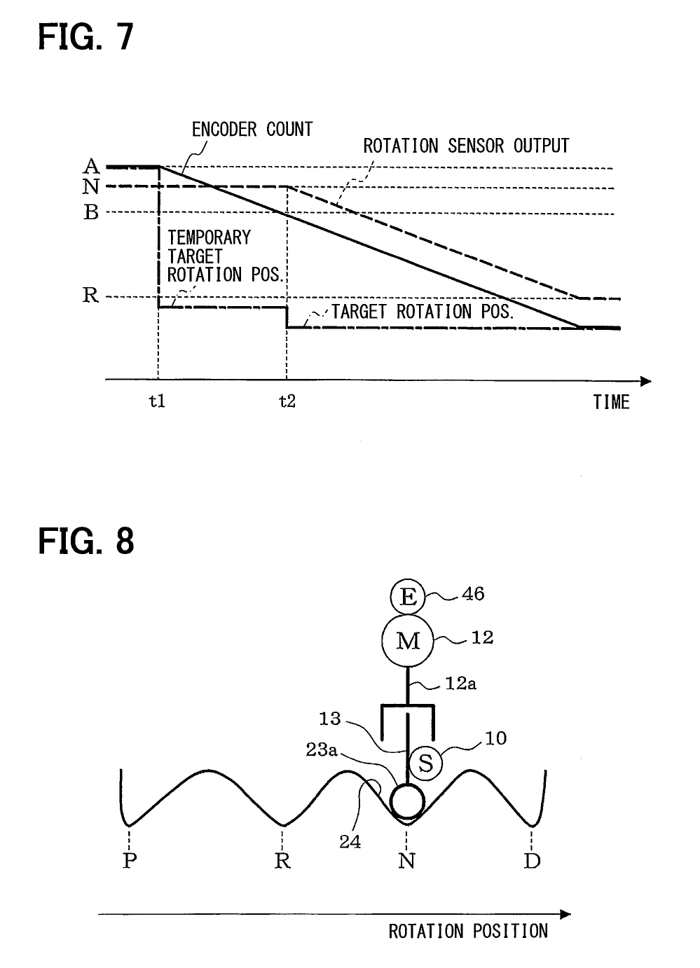

An example of how a target rotation position setting of the present embodiment is performed is now described with reference to a time chart of FIG. 7.

At a time t1, at which a target range is switched from the N range to the R range after the start of the microcomputer 41, a temporary target rotation position (i.e., A−RN) is set up based on (i) the initial rotation position A (i.e., a stop position before rotating the motor 12) and (ii) the by-design value RN of the rotation amount from a rotation position corresponding to the N range to a rotation position corresponding to the R range. According to the above, the motor 12 is rotated in the R range direction.

When, thereafter, the slack of the rotation transmission system is removed in the R range direction, which causes the output of the rotation sensor 16 to start to change at a time t2, the encoder count at such a moment is detected as the slack removed rotation position B. In such manner, a rotation position at which the slack of the rotation transmission system is removed in the R range direction is detected as the slack removed rotation position B.

Then, the target rotation position (i.e., B−RN) is set up based on (i) the slack removed rotation position B and (ii) the by-design value RN of the rotation amount from an N range rotation position to an R range rotation position respectively corresponding to the N range and the R range. In such manner, without learning a slack amount in the rotation transmission system, a target rotation position for switching the shift range to the R range is with improved set with improved accuracy. Thereby, the improved accuracy of control at a shift range switch time is achieved without performing an abutment control for rotating the motor 12 to the limit position of the movable range of the range switch mechanism 11.

In the above-mentioned first embodiment, the detection of a slack removed rotation position and the setting up of the target rotation position are performed when a target range is switched from the N range to the R range. However, for example, the slack removed rotation position may be detected and the target rotation position may be set when a target range is switched from the N range to a P range or a D range. Further, the slack removed rotation position may also be detected and the target rotation position may also be set when a target range is switched from the R range to the N range, to the P range, or to the D range. Furthermore, every time when a target range is switched, the slack removed rotation position may be detected and the target rotation position may be set.

### Second Embodiment

The second embodiment of the present disclosure is described with reference to FIGS. 8 to 14. The description of the previously described parts in the first embodiment may be omitted or simplified.

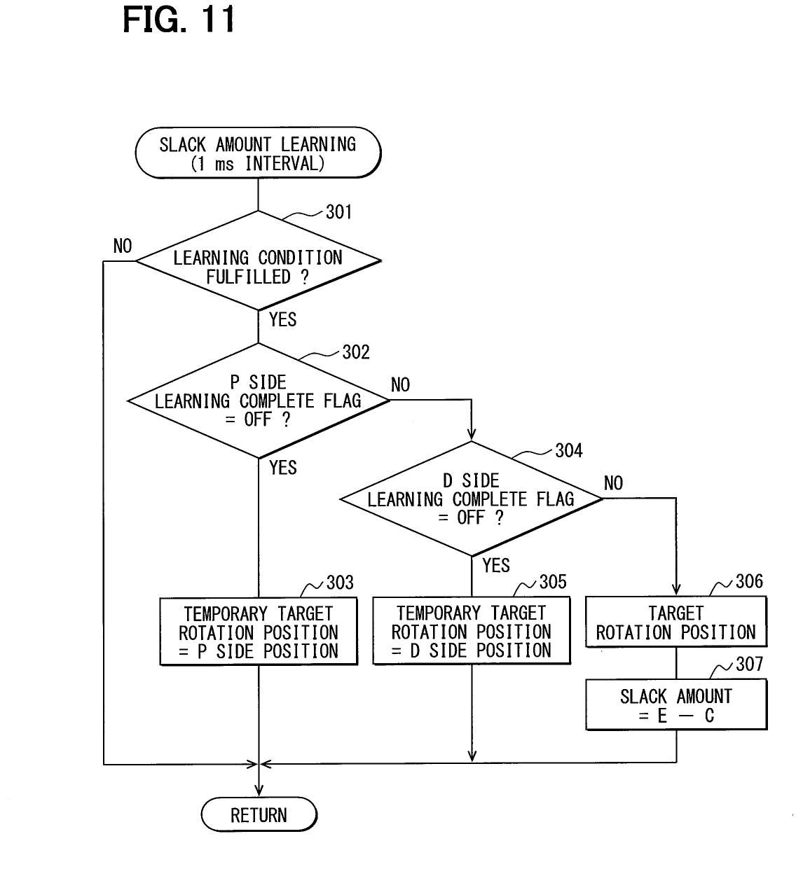

In the second embodiment, by executing the routines in FIGS. 11 to 13, the following two rotation positions are learned. That is, each of the routines in FIGS. 11 to 13 is executed by the microcomputer 41 of the range switch controller 42, for the learning of the amount of slack in the rotation transmission system when a preset learn condition is fulfilled, based on a first encoder count of the rotation sensor 16 at a first output change start time that is when a rotation of the motor 12 from an initial position along a first rotation direction is caused and a second encoder count of the rotation sensor 16 at a second output change start time when a rotation of the motor 12 from the initial position along a second rotation direction that is opposite to the first rotation direction is caused. Further, when the motor 12 is rotated to switch the shift range, the target rotation position is set in consideration of a learned value of the amount of slack.

The first encoder count of the rotation sensor 16 at the first output change start time, when a rotation of the motor 12 is caused from the initial position along the first rotation direction and the output of the rotation sensor starts to change, marks a first slack removed rotation position in such rotation direction with which no slack of the rotation transmission system is left un-removed, and the second encoder count of the rotation sensor 16 at the second output change start time, when a rotation of the motor 12 is caused from the initial position along the second rotation direction opposite to the first rotation direction and the output of the rotation sensor starts to change, marks a second slack removed rotation position in such rotation direction with which no slack of the rotation transmission system is left un-removed.

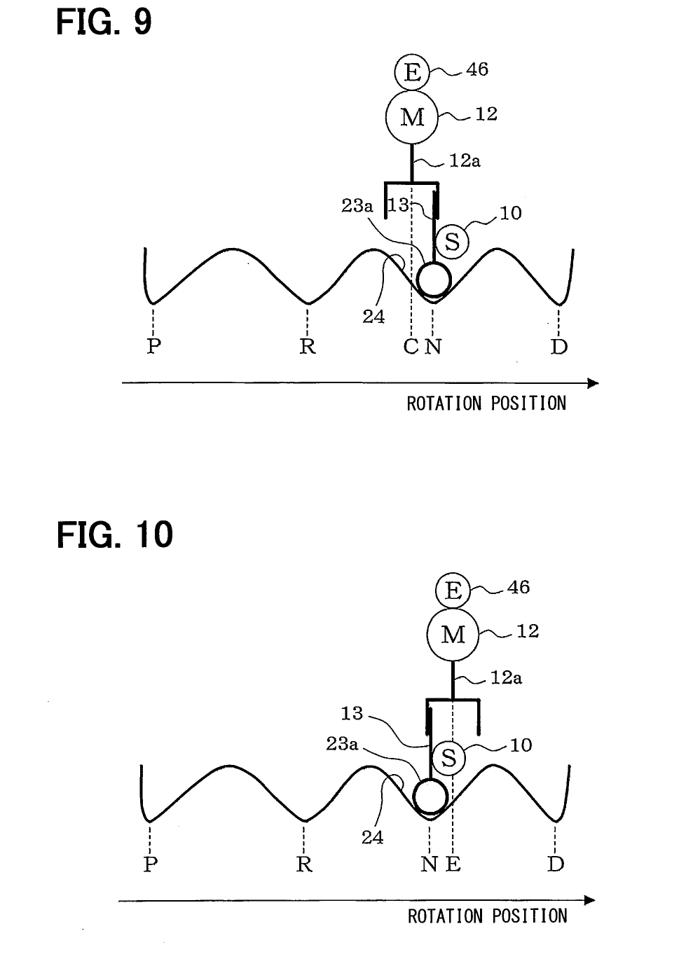

Based on the above-described characteristics in the present embodiment, when the shift range at the start time of the microcomputer 41 is in the N range as shown in FIG. 8, for example, in which no abutment control is performable, the motor 12 is rotated from the initial position (i.e., a stop position before rotating the motor 12) in a predetermined direction, e.g., in the P range direction, and, when the output of the rotation sensor 16 starts to change according to such rotation of the motor 12 as shown in FIG. 9, an encoder count of such moment is detected as a P-side slack removed rotation position C. In such manner, when the rotation position of the motor 12 reaches a slack removed rotation position of the rotation transmission system in the P range direction, such a position is detected as the P-side slack removed rotation position C.

Further, as shown in FIG. 10, an encoder count at an output change start time, i.e., when the output of the rotation sensor 16 starts to change during the motor rotation along the opposite direction that is opposite to the predetermined direction, e.g., in the D range direction, from the initial position, is detected as a D-side slack removed rotation position E. In such manner, when the rotation position of the motor 12 reaches a slack removed rotation position of the rotation transmission system in the P range direction, such a position is detected as the D-side slack removed rotation position E.

Then, the amount of slack is learned with improved accuracy by calculating and learning the amount of slack in a rotation transmission system of the motor 12 based on the P-side slack removed rotation position C and the D-side slack removed rotation position E.

Amount of slack=E−C

Therefore, when the switching of the shift range is performed, the learned value of the amount of slack learned in the above-described manner is taken into consideration for the setting of the target rotation position, for an accurate setting of the target rotation position at a shift range switch time.

The process of each of the three routines in FIGS. 11 to 13 executed by the microcomputer 41 of the range switch controller 42 is described below.

[Slack Amount Learning Routine]

The slack amount learning routine shown in FIG. 11 is repeatedly executed at predetermined intervals (e.g., at a cycle of 1 ms) by the microcomputer 41 during a power turn-ON period of the range switch controller 42.

After the start of the present routine, it is initially determined in step 301 whether a predetermined learning condition is fulfilled based on, for example, whether (i) the shift range is the N range and (ii) the slack amount is not yet learned after a current start-up. When it is determined by the present routine that the learning condition is not fulfilled, the routine is finished without performing step 301 and subsequent steps.

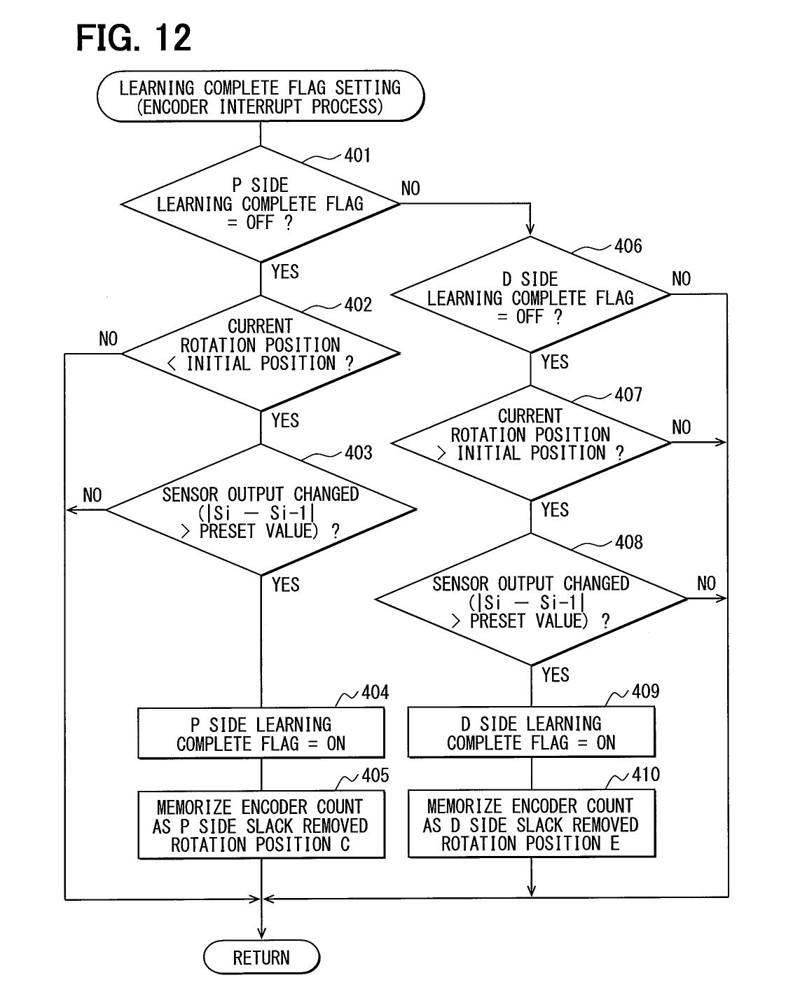

On the other hand, when it is determined that the learning condition is fulfilled in the above-mentioned step 301, the process proceeds to step 302, and it is determined whether a P-side learning completion flag is OFF. The P-side learning completion flag is set up by a routine in FIG. 12, which is mentioned later.

In step 302, when it is determined that the P-side learning completion flag is OFF, the process proceeds to step 303, and a temporary target rotation position is set as a P-side position. The P-side position is a rotation position on a P range side relative to the initial position, and is set as an encoder count that is sufficiently smaller than the encoder count of the initial position. Thereby, the microcomputer 41 of the range switch controller 42 rotates the motor 12 in the P range direction.

When, thereafter, it is determined that the P-side learning completion flag is ON in the above-mentioned step 302, the process proceeds to step 304, and it is determined whether a D-side learning completion flag is OFF. The D-side learning completion flag is set up by the routine of FIG. 12, which is mentioned later.

In step 304, when it is determined that the D-side learning completion flag is OFF, the process proceeds to step 305, and a temporary target rotation position is set as a D-side position. The P-side position is a rotation position on a D range side relative to the initial position, and is set as an encoder count that is sufficiently greater than the encoder count of the initial position. Thereby, the microcomputer 41 of the range switch controller 42 rotates the motor 12 in the D range direction.

When, thereafter, it is determined that the D-side learning completion flag is ON in the above-mentioned step 304, the process proceeds to step 306, and the target rotation position is returned to the initial position. Thereby, the microcomputer 41 of the range switch controller 42 returns the rotation position of the motor 12 to the initial position.

Then, the process proceeds to step 307, and the amount of slack in the rotation transmission system of the motor 12 is calculated and learned based on the P-side slack removed rotation position C and the D-side slack removed rotation position E. The P-side slack removed rotation position C and the D-side slack removed rotation position E are detected by the routine of FIG. 12, which is mentioned later.

Amount of slack=E−C

[Learning Complete Flag Setting Routine]

The learning complete flag setting routine shown in FIG. 12 is started by the microcomputer 41 during the power turn-ON period of the range switch controller 42 in synchronization with both of a rising edge and a falling edge of the A-phase signal and the B-phase signal which are outputted from the encoder 46.

After the start of the present routine, it is determined first whether the P-side learning completion flag is OFF in step 401.

When it is determined that the P-side learning completion flag is OFF in step 401, the process proceeds to step 402, and then it is determined whether the current position (i.e., the present rotation position) of the motor 12 is on a P range side relative to the initial position, and, when it is determined that the current position of the motor 12 is on the P range side relative to the initial position, the process proceeds to step 403, and then it is determined whether the output of the rotation sensor 16 has changed based on, for example, whether an absolute value of difference between a current output value Si and a previous output value Si−1 of the rotation sensor 16 is greater than a predetermined value (e.g., zero or a value greater than zero).

The present routine is finished without performing a process of steps 404, 405, when it is determined that the output of the rotation sensor 16 has not changed in step 403.

When, thereafter, it is determined that the output of the rotation sensor 16 has changed in the above-mentioned step 403, after proceeding to step 404 and setting the P-side learning completion flag to ON, the process proceeds to step 405, and detects and memorizes a current encoder count (i.e., an encoder count when the output of the rotation sensor 16 starts to change) as the P-side slack removed rotation position C.

Then, it is determined that the P-side learning completion flag is ON in the above-mentioned step 401, the process proceeds to step 406, and it is determined whether the D-side learning completion flag is OFF.

When it is determined that the D-side learning completion flag is OFF in step 406, the process proceeds to step 407, and then it is determined whether the current position (the present rotation position) of the motor 12 is on a D range side relative to the initial position, and, when it is determined that the current position of the motor 12 is on the D range side relative to the initial position, the process proceeds to step 408, and it is determined whether the output of the rotation sensor 16 has changed based on, for example, whether an absolute value of the difference between a current output value Si and a previous output value Si−1 of the rotation sensor 16 is greater than a predetermined value (e.g., zero or a value greater than zero).

The present routine is finished without performing a process of steps 409, 410, when it is determined that the output of the rotation sensor 16 has not changed in step 408.

When, thereafter, it is determined that the output of the rotation sensor 16 has changed in the above-mentioned step 408, after proceeding to step 409 and setting the D-side learning completion flag to ON, the process proceeds to step 410, and detects and memorizes a current encoder count (i.e., an encoder count when the output of the rotation sensor 16 starts to change) as the D-side slack removed rotation position E.

In the second embodiment, the slack amount learning routine of FIG. 11 and the learning complete flag setting routine of FIG. 12 respectively serve as a slack amount learning part in the claims.

[Target Rotation Position Setting Routine]

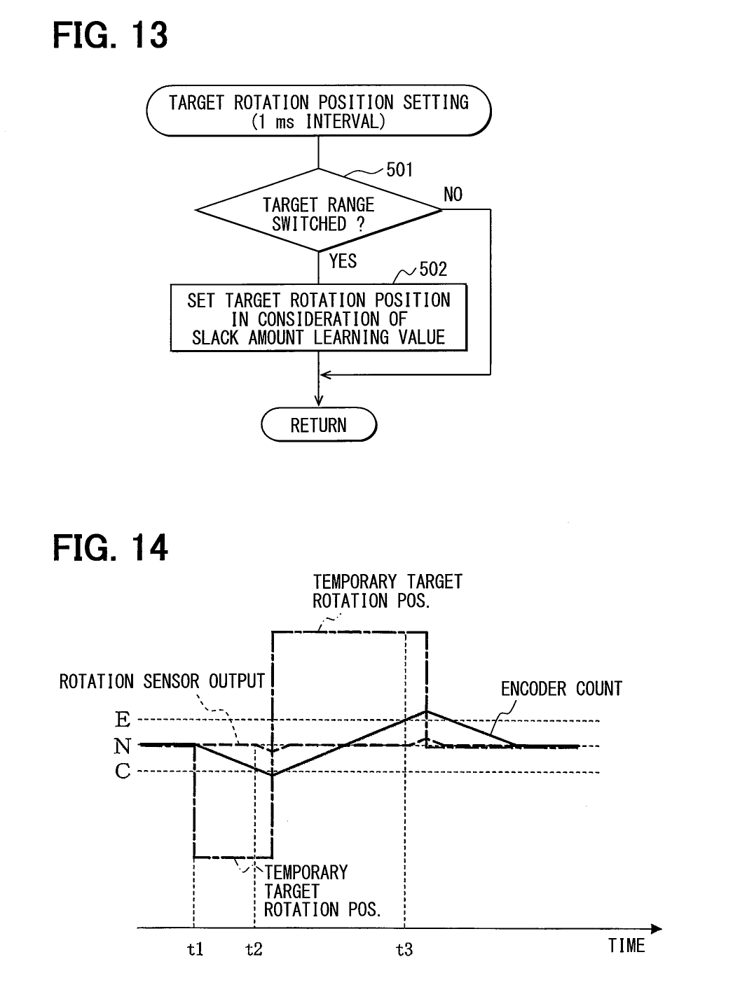

The target rotation position setting routine shown in FIG. 13 is repeatedly executed at predetermined intervals (e.g., a cycle of 1 ms) by the microcomputer 41 during the power turn-ON period of the range switch controller 42, and serves as a target rotation position setting part in the claims.

After the start of the present routine, it is first determined whether the target range is switched in step 501. The present routine is finished without performing a process of step 502 and subsequent steps, when it is determined that the target range has not been switched in step 501.

When, thereafter, it is determined that the target range has been switched in the above-mentioned step 501, the process proceeds to step 502, and sets a target rotation position in consideration of the learned value of the amount of slack. In this case, the target rotation position is set up based on the by-design value of the rotation amount between a pre-switching rotation position corresponding to the current shift range and a post-switching rotation position corresponding to the target shift range.

An example of how a slack amount learning of the present embodiment is performed is now described with reference to a time chart of FIG. 14.

When the predetermined learning condition is fulfilled after the start of the microcomputer 41 (e.g., when the shift range is the N range and the slack amount has not been learned after the current start-up), a temporary target value is set as the P-side position (e.g., an encoder count sufficiently smaller than the initial position) at time t1. Thereby, the motor 12 is rotated in the P range direction.

When, thereafter, the slack of the rotation transmission system is removed in the P range direction and the output of the rotation sensor 16 starts to change at time t2, the encoder count at such a moment is detected as the P-side slack removed rotation position C. In such manner, when the rotation position of the motor 12 reaches a slack removed rotation position of the rotation transmission system in the P range direction, such a position is detected as the P-side slack removed rotation position C.

Then, the temporary target rotation position is set as the D-side position. The P-side position is a rotation position on a D range side relative to the initial position, and is set as an encoder count that is sufficiently greater than the encoder count of the initial position. Thereby, the microcomputer 41 of the range switch controller 42 rotates the motor 12 in the D range direction.

When, thereafter, the slack of the rotation transmission system is removed in the D range direction and the output of the rotation sensor 16 starts to change at time t3, the encoder count at such a moment is detected as the D-side slack removed rotation position E. In such manner, when the rotation position of the motor 12 reaches a slack removed rotation position of the rotation transmission system in the D range direction, such a position is detected as the D-side slack removed rotation position E.

After detecting the P-side slack removed rotation position C and the D-side slack removed rotation position E, the amount of slack is learned with improved accuracy by calculating and learning the amount of slack of the rotation transmission system of the motor 12 (i.e., E−C) based on the P-side slack removed rotation position C and the D-side slack removed rotation position E.

Further, by setting the target rotation position in consideration of the learned value of the amount of slack when the target range is switched, the target rotation position for switching the shift range to the target shift range is set with the improved accuracy, and the improved accuracy of control at a shift range switch time is achieved without performing an abutment control for rotating the motor 12 to the limit position of the movable range of the range switch mechanism 11.

In the above-mentioned second embodiment, when the shift range is the N range, the amount of slack is learned by detecting the slack removed rotation positions on both sides (i.e., the P-side slack removed rotation position and the D-side slack removed rotation position). However, even when the shift range is the range other than the N range (i.e., when the shift range is R/P/D range), the amount of slack may also be learned by detecting the slack removed rotation positions on both sides of those ranges.

Further, in the above-mentioned second embodiment, the amount of slack is learned only once by detecting the slack removed rotation positions on both sides when the amount of slack is not yet learned after the start of the microcomputer 41. However, for example, even after firstly detecting the slack removed rotation positions on both sides for the learning of the amount of slack after the start of the microcomputer 41, the amount of slack may be repeatedly learned (i.e., updated) at predetermined intervals or whenever the shift range is switched, by detecting the slack removed rotation positions on both sides.

In the above-mentioned first and second embodiments, the encoder 46 is a magnetic type encoder. However, the encoder 46 may also be an optical encoder or a brush-type encoder, for example. Further, the encoder 46 is not necessarily limited to an encoder which outputs an A-phase signal and a B-phase signal, but may also be an encoder which outputs a Z-phase signal for correction (i.e., index) purpose, in addition to the A/B-phase signals.

Further, the switched-reluctance motor (i.e. an SR motor) used in each of the above-mentioned first and second embodiments as the motor 12 may also be other brushless type motors as long as the power supply phase of such motor is sequentially switched based on a rotation position of the motor detected by the count value of the output signal from the encoder.

Further, although the present disclosure is applied to a system that is provided with the range switch mechanism for switching the shift range between the P range, the R range, the N range, and the D range, i.e., among four ranges, in each of the above-mentioned first to third embodiments, the present disclosure may also be applicable to a system that is provided with a range switch mechanism for switching between the P range and a non-P range, i.e., between two ranges. Furthermore, the present disclosure may further be applicable to a system that is provided with a range switch mechanism for switching among three ranges or among multiple ranges, e.g., five or more ranges.

Further, the present disclosure is applicable not only to an automatic transmission mechanism (i.e., AT, CVT, DCT, etc.), but also to a range switch device for switching the shift ranges in a speed reducer for an electric vehicle or the like.

Although the present disclosure has been fully described in connection with preferred embodiment thereof with reference to the accompanying drawings, it is to be noted that various changes and modifications will become apparent to those skilled in the art, and such changes, modifications, and summarized schemes are to be understood as being within the scope of the present disclosure as defined by appended claims.

What is claimed is:

1. A range switch device comprising:
a range switch mechanism having a plurality of shift ranges;
a motor driving an operating shaft of the range switch mechanism to switch a shift range between one of the plurality of shift ranges;
an encoder sensing a rotation of the motor and outputting a pulse signal in synchronization with the rotation of the motor;
a controller controlling the motor to rotate, based on an encoder count of the output of the pulse signal from the encoder, to a target rotation position that corresponds to a target shift range to switch the shift range to the target shift range;
a rotation sensor outputting an output signal according to a rotation angle of the operating shaft of the range switch mechanism which is rotated by the motor; and
a target rotation position setting part detecting a slack removed position of the motor and setting the target rotation position when the motor rotates to switch to the target rotation position, wherein
the slack removed position is defined as a rotation position of the motor based on an encoder count that indicates a start of a changing of the output signal from the rotation sensor, and
the target rotation position of the motor is set based on (a) the slack removed position of the motor and (b) a by-design rotation amount of the motor between a pre-switching shift range and the target shift range.

2. A range switch device comprising:
a range switch mechanism having a plurality of shift ranges;
a motor driving an operating shaft of the range switch mechanism to switch a shift range between one of the plurality of shift ranges;
an encoder sensing a rotation of the motor and outputting a rotation position of the motor as an encoder count;
a controller controlling the motor to rotate, based on the encoder count, to a target rotation position that corresponds to a target shift range to switch the shift range to the target shift range;
a rotation sensor outputting a signal indicative of a rotation angle of an operating shaft of the range switch mechanism which is rotated by the motor;
a slack amount learning part that learns, when a preset learn condition is fulfilled, an amount of slack in a rotation transmission system that transmits a rotation of the motor based on
(i) a first encoder count of the rotation sensor at a first output change start time when the motor rotates relative to the initial position along a first rotation direction, and
(ii) a second encoder count of the rotation sensor at a second output change start time when the motor rotates relative to the initial position along a second rotation direction that is opposite to the first rotation direction; and
a target rotation position setting part that sets, when the motor is caused to rotate to switch the shift range, the target rotation position according to a learned value of the amount of slack.
